(19) United States
(12) Patent Application Publication
(10) Pub. No.: US 2026/0009996 A1
(43) Pub. Date: Jan. 8, 2026

(54) SLIDE STAGE AND SLIDE IMAGING DEVICE INCLUDING THE SAME

(71) Applicant: Vieworks Co., Ltd., Anyang-si (KR)

(72) Inventors: Chang Woo KANG, Anyang-si (KR); Hee Woong YANG, Incheon (KR); Chang Hyuk LIM, Hwaseong-si (KR); Jung Hoon CHOI, Suwon-si (KR)

(21) Appl. No.: 19/259,746

(22) Filed: Jul. 3, 2025

(30) Foreign Application Priority Data
Jul. 4, 2024 (KR) 10-2024-0088326

(51) Int. Cl. G02B 21/26; B01L 9/00; G02B 21/34

(52) U.S. Cl. CPC G02B 21/26; B01L 9/52; G02B 21/34; B01L 2300/0822

(57) ABSTRACT

An embodiment relates to a slide stage on which a slide on which a sample is placed is aligned and fixed, and a slide imaging device including the same. The stage provided in a slide imaging device includes a main plate having a slide loading portion onto which a slide is loaded, a main lever provided on the main plate and configured to be movable in a first direction, and at least one of a slide lateral surface pressing part configured to press or release a lateral surface of the slide in conjunction with a movement of the main lever in the first direction or a slide end fixing part configured to press or release an end of the slide in conjunction with the movement of the main lever in the first direction.

### CROSS-REFERENCE TO RELATED APPLICATIONS

This application claims priority to and the benefit of Korean Patent Application No. 10- 2024-0088326 filed in the Korean Intellectual Property Office on July 4, 2024, the entire contents of which are incorporated herein by reference.

### TECHNICAL FIELD

The present invention relates to a slide stage on which a slide on which a sample is placed is aligned and fixed, and a slide imaging device including the same.

### BACKGROUND ART

A scanning device, which is used in conjunction with a microscope, is known. For example, a slide scanner is a device configured to automatically scan a slide on which a tissue sample to be inspected is placed and store, observe, and/or analyze images. The slide scanner is used to acquire images of tissue samples during various preclinical experiments or pathology tests. In the slide scanner, the slide needs to be aligned and fixed at an accurate position on a stage. For example, a gripper configured to grip the slide may be used to transfer the slide to the stage, and a fixing device provided on the stage may be used to align and fix the slide at a predetermined position on the stage.

However, the amount of time required to align and fix the slide on the stage directly affects the amount of time required for slide scanning. Therefore, there is a need to automate functions of transferring the slide to the stage and aligning and fixing the slide and to reduce the required amount of time.

### [Documents of Related Art]

### [Patent Documents]

Korean Patent Application Laid-Open No. 10-2021-0122083

U.S. Patent No. 1156232

### SUMMARY OF THE INVENTION

The present invention has been made in an effort to provide a slide stage capable of automatically aligning and fixing a position of a slide transferred to the stage, and a slide imaging device including the same.

The present invention provides a stage provided in a slide imaging device, the stage including: a main plate having a slide loading portion onto which a slide is loaded; a main lever provided on the main plate and configured to be movable in a first direction; and at least one of a slide lateral surface pressing part configured to press or release a lateral surface of the slide in conjunction with a movement of the main lever in the first direction or a slide end fixing part configured to press or release an end of the slide in conjunction with the movement of the main lever in the first direction.

In the embodiment, the main lever may be moved rearward in the first direction relative to the main plate as a part of the main lever comes into contact with a structure provided in the slide imaging device when the stage moves to a loading or unloading position of the slide.

In addition, a main lever operating bumper protruding from the main lever may be provided on the main lever, and the structure of the slide imaging device may be a bumper pusher configured to come into contact with the main lever operating bumper.

In addition, a main lever mounting portion on which the main lever is mounted and movable in the first direction may be provided as a groove structure in the main plate, and the main lever mounting portion may have a main lever spring configured to provide a restoring force to the main lever.

In the embodiment, a lateral surface pressing part mounting portion may be formed on the main plate and configured to guide the slide lateral surface pressing part in a direction traversing the main lever.

In the embodiment, the slide lateral surface pressing part may include: a sliding block disposed on the lateral surface pressing part mounting portion; and a slide contact portion configured to come into contact with the lateral surface of the slide.

In addition, the main lever may have an inclined surface, the sliding block may have an inclined surface contact portion configured to adjoin the inclined surface, and the sliding block may be elastically supported by a lateral surface pressing part spring, such that the slide lateral surface pressing part may be moved, by a movement of the main lever in the first direction, to a position at which the slide lateral surface pressing part presses or releases the lateral surface of the slide.

In addition, the stage may further include: a lateral surface pressing part spring bracket coupled to the main plate to prevent separation of the lateral surface pressing part spring. In the embodiment, the slide end fixing part may be mounted on an end fixing part mounting portion, which is provided at one side of the slide loading portion of the main plate, and configured to be movable in the first direction.

In the embodiment, the slide end fixing part may include a flat spring configured to press an upper portion of one side of the slide, and one end of the slide end fixing part may come into contact with one side of the slide to align the slide in the first direction.

In addition, the end fixing part mounting portion may have an unfixing protrusion configured to move the flat spring upward when the slide end fixing part moves in a direction away from the slide.

In addition, sliding guides may be formed at two opposite sides of the slide end fixing part and configured to assist a sliding movement of the slide end fixing part.

In the embodiment, the stage may further include: a driving link configured to connect one end of the main lever and the slide end fixing part to allow the main lever and the slide end fixing part to operate in conjunction with each other.

In the embodiment, the driving link may include: a rotation center hole provided in a central portion thereof and rotatably coupled to the main plate; a main lever connection hole connected to the main lever and having a long hole shape; and an operating protrusion connected to the slide end fixing part.

In the embodiment, the slide end fixing part may have an operating hole having a long hole shape into which the operating protrusion is inserted.

In addition, the present invention provides a slide imaging device including: a casing having an internal space; an image capturing part provided in the casing; and a slide assembly onto which a slide, which is to be subjected to image capturing by the image capturing part, is loaded, in which the slide assembly includes the stage.

In the embodiment, the stage may be mounted on a block configured to be movable in at least one of the first direction or a second direction perpendicular to the first direction. In addition, the slide imaging device may further include: a slide loader configured to load or unload the slide onto or from the stage.

In addition, the slide may be loaded or unloaded by the slide loader after the stage reaches a position at which the slide is loaded or unloaded.

In addition, a bumper pusher configured to come into contact with the main lever of the stage and move the main lever rearward may be provided at the position at which the slide is loaded or unloaded.

According to the present invention, the position of the slide is automatically aligned and fixed when the slide is loaded onto the stage, such that the operation of capturing images of the slide may be quickly prepared, and the slide may be easily loaded onto or unloaded from the stage.

The foregoing summary is illustrative only and is not intended to be in any way limiting.

In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view illustrating a schematic configuration of a slide imaging device according to an embodiment of the present invention.

FIG. 2 is a perspective view of a stage assembly provided in the slide imaging device according to the embodiment of the present invention.

FIG. 3 is a perspective view of a stage provided in a stage assembly of the slide imaging device according to the embodiment of the present invention.

FIG. 4 is a perspective view of a main plate of the stage according to the embodiment of the present invention.

FIG. 5 is a view illustrating a state in which the slide is loaded onto the main plate of the stage according to the embodiment of the present invention.

FIG. 6 is a view illustrating a state in which a main lever is mounted on the main plate of the stage according to the embodiment of the present invention.

FIG. 7 is a view illustrating a cross-section (cross-section taken along line B-B' in FIG. 3) in the state in which the main lever is mounted on the main plate of the stage according to the embodiment of the present invention.

FIG. 8 is a view illustrating a state in which the main lever of the stage according to the embodiment of the present invention operates to be pressed against a bumper pusher provided in the slide imaging device.

FIG. 9 is a view illustrating a state in which a slide lateral surface pressing part is coupled to the main plate of the stage according to the embodiment of the present invention.

FIG. 10 is a view illustrating a state in which the slide lateral surface pressing part operates in accordance with an operation of the main lever in the stage according to the embodiment of the present invention.

FIG. 11 is a view illustrating a state in which a slide end fixing part and a driving link, which is configured to operate the slide end fixing part, are mounted on the main plate of the stage according to the embodiment of the present invention.

FIG. 12 is a view illustrating the driving link provided in the stage according to the embodiment of the present invention.

FIG. 13 is a perspective view of the slide end fixing part provided in the stage according to the embodiment of the present invention.

FIG. 14 is a view illustrating a state in which the driving link operates the slide end fixing part while being rotated by the operation of the main lever in the stage according to the embodiment of the present invention.

FIG. 15 is a view illustrating a state in which the slide is loaded onto the stage according to the embodiment of the present invention, and the slide is aligned and fixed by the slide lateral surface pressing part and the slide end fixing part by the operation of the main lever.

FIG. 16 is a view illustrating a state in which the slide is loaded onto the stage according to the embodiment of the present invention by using a slide loader.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The present invention may be variously modified and may have various exemplary embodiments, and particular exemplary embodiments illustrated in the drawings will be described specifically below. However, the description of the exemplary embodiments is not intended to limit the present invention to the particular exemplary embodiments, but it may be understood that the present invention is to cover all modifications, equivalents and alternatives falling within the technical spirit and technical scope of the present invention. In the description of the present invention, the specific descriptions of publicly known related technologies will be omitted when it is determined that the specific descriptions may obscure the subject matter of the present invention.

The terms such as "first" and "second" may be used to describe various constituent elements, but the constituent elements should not be limited by the terms. These terms are used only to distinguish one constituent element from another constituent element.

The terminology used herein is used for the purpose of describing particular embodiments only and is not intended to limit the present invention. The terms used in the present invention are selected from general terms currently widely used in the art in consideration of functions in the present invention, but the terms may vary according to the intention of those skilled in the art, precedents, or new technology in the art. Further, specified terms are selected arbitrarily by the applicant, and in this case, the detailed meaning thereof will be described in the detailed description of the disclosure. Thus, the terms used in the present invention should be defined based not on simple names but on the meaning of the terms and the overall description of the present invention.

Singular expressions include plural expressions unless clearly described as different meanings in the context. In the present invention, the terms "comprises," "comprising," "includes," "including," "containing," "has," "having" or other variations thereof are inclusive and therefore specify the presence of stated features, integers, steps, operations, elements, components, and/or combinations thereof, but do not preclude the presence or addition of one or more other features, integers, steps, operations, elements, components, and/or combinations thereof.

Hereinafter, the embodiments of the present invention will be described in detail with reference to the accompanying drawings. In the description of the exemplary embodiments with reference to the accompanying drawings, the same or corresponding constituent elements are assigned with the same reference numerals, and the repetitive description thereof will be omitted.

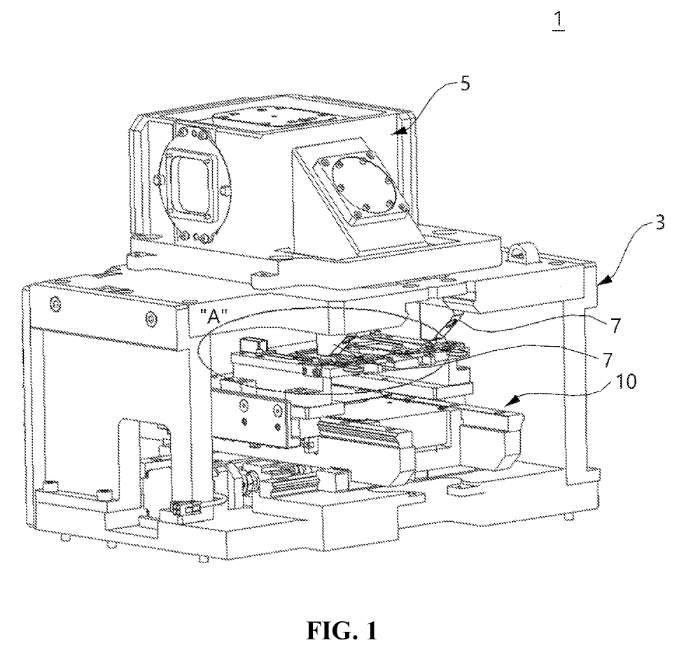

FIG. 1 is a perspective view illustrating a schematic configuration of a slide imaging device according to an embodiment of the present invention.

A slide imaging device 1 according to an embodiment of the present invention includes a casing 3, an image capturing part 5 provided above the casing 3, and a stage assembly 10 onto which a slide, which is to be subjected to image capturing, is loaded. In the embodiment, bumper pushers 7 may be provided at predetermined positions in the casing 3 and configured to push main lever operating bumpers 32 of main levers 30 provided on a stage 100 of the stage assembly 10.

The slide imaging device 1 captures images of the slide by using the image capturing part 5 in a state in which the slide is loaded onto the stage of the stage assembly 10. The configuration of the image capturing part 5 provided in the slide imaging device 1 may have components typically known in the technical field to which the present invention pertains, and detailed descriptions of the components will be omitted.

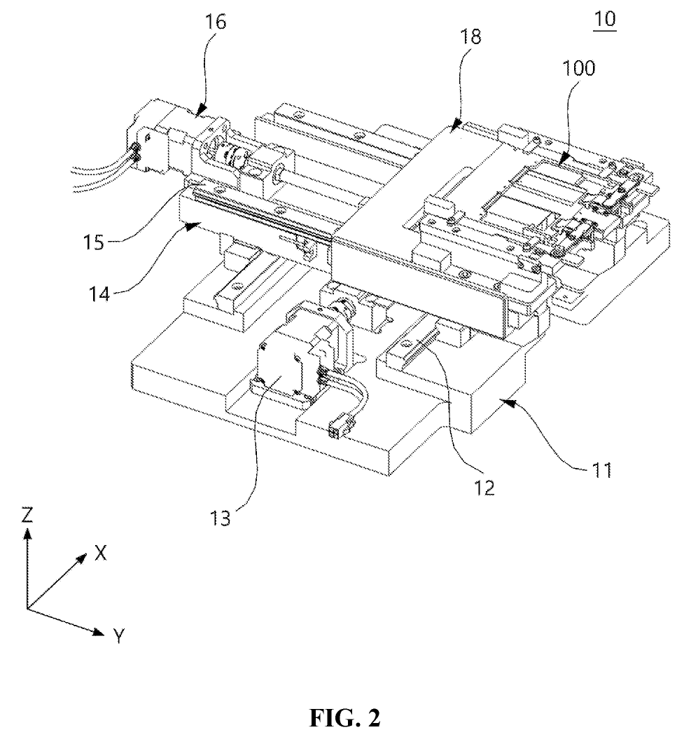

FIG. 2 is a perspective view of the stage assembly provided in the slide imaging device according to the embodiment of the present invention.

In the embodiment, the stage assembly 10 may include a base 11, a first block 14 provided above the base and configured to be movable in a second direction (X-axis direction in FIG. 2), a second block 18 provided above the first block 14 and configured to be movable in a first direction (Y-axis direction in FIG. 2), and the stage 100 coupled to the second block 18.

The base 11 may be fixed in an internal space of the slide imaging device 1. A first rail 12 formed in the second direction may be provided on an upper surface of the base 11, and a first driving part 13 may be provided on the upper surface of the base 11.

The first block 14 may be moved in the second direction along the first rail 12 by the first driving part 13. A second rail 15 formed in the first direction may be provided on an upper surface of the first block 14, and a second driving part 16 may be provided on the upper surface of the first block 14.

The second block 18 may be moved in the first direction along the second rail 15 by the second driving part 16. In the embodiment, the first driving part 13 and the second driving part 16 may each include an electric motor, and a ball screw module configured to convert a rotational motion of the electric motor into a rectilinear motion.

The stage 100 may be fixed to an upper portion of the second block 18 and moved in the second direction and/or the first direction by the operations of the first driving part 13 and/or the second driving part 16. The stage 100 may be moved by the operations of the first driving part and/or the second driving part 16 to a position at which the slide is loaded or unloaded, such that the slide may be loaded or unloaded. The stage 100 may be moved to a position at which the image capturing part 5 captures images of the slide. With the configuration of the stage assembly 10 illustrated in FIG. 2, the stage 100 may be moved in the X-axis direction and the Y-axis direction. In some instances, the stage 100 may be moved only in the Y-axis direction. An additional driving part may be further provided to move the stage 100 in the Z-axis direction.

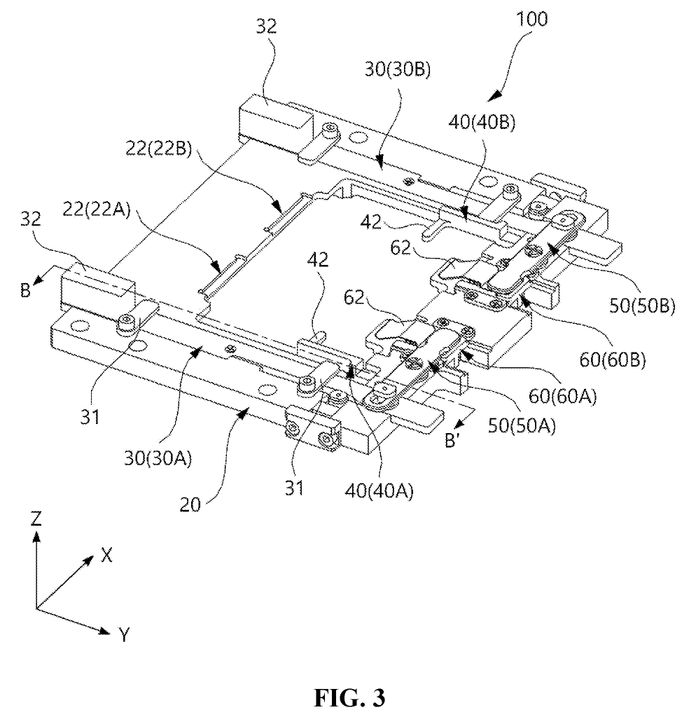

FIG. 3 is a perspective view of the stage provided in the stage assembly of the slide imaging device according to the embodiment of the present invention.

With reference to FIG. 3, the stage 100 may include a main plate 20 having slide loading portions 22 onto which the slide is loaded, the main levers 30 configured to be movable in the first direction on the main plate 20, slide lateral surface pressing parts 40 configured to press lateral surfaces of the slide in conjunction with the main levers 30, and slide end fixing parts 60 configured to press an end of the slide in conjunction with the main levers 30. In addition, the stage 100 may further include driving links 50 configured to connect operations of the main levers 30 to the slide end fixing parts 60.

In the embodiment in FIG. 3, the two slide loading portions 22 include a first slide loading portion 22A and a second slide loading portion 22B. The main levers 30 include a first main lever 30A and a second main lever 30B corresponding to the first slide loading portion 22A and the second slide loading portion 22B. The slide lateral surface pressing parts 40 include a first slide lateral surface pressing part 40A and a second slide lateral surface pressing part 40B. The slide end fixing parts 60 include a first slide end fixing part 60A and a second slide end fixing part 60B. The driving links 50 include a first driving link 50A and a second driving link SOB. However, in the embodiment of the present invention, one slide loading portion 22, one main lever 30, one slide lateral surface pressing part 40, one driving link 50, and one slide end fixing part 60 may be provided, or three or more slide loading portions 22, three or more main levers 30, three or more slide lateral surface pressing parts 40, three or more driving links 50, and three or more slide end fixing parts 60 may be provided.

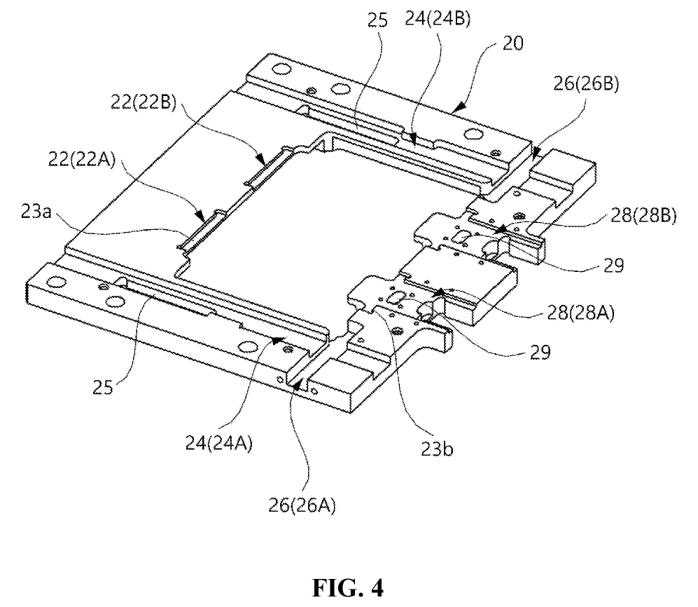

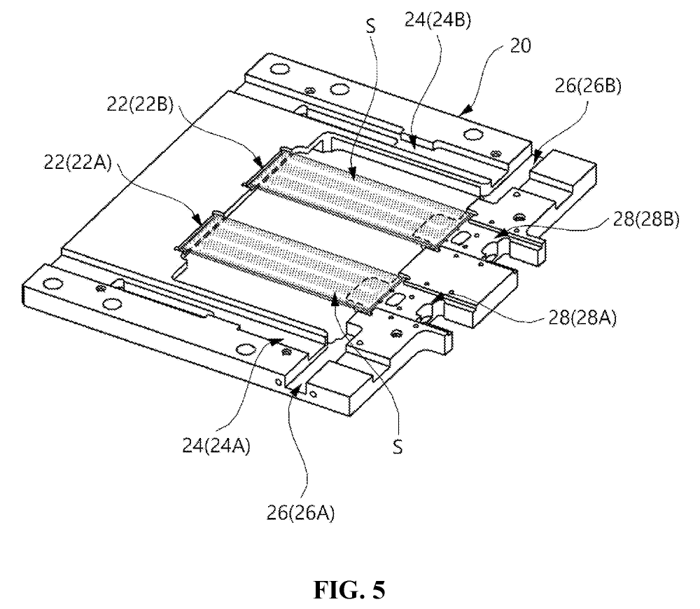

FIG. 4 is a perspective view of the main plate of the stage according to the embodiment of the present invention, and FIG. 5 is a view illustrating a state in which the slide is loaded onto the main plate of the stage according to the embodiment of the present invention.

With reference to FIGS. 4 and 5, the main plate 20 has the slide loading portions 22 and includes a structure on which the main levers 30, the slide lateral surface pressing parts 40, the driving links 50, and the slide end fixing parts 60 are mounted.

The slide loading portion 22 may include a first groove portion 23a and a second groove portion 23b. The first groove portion 23a and the second groove portion 23b constitute a groove into which two opposite ends of a slide S are inserted. Meanwhile, a portion of the main plate 20, which has the slide loading portion 22, may be formed to be penetrated upward and downward to capture images of the slide S. However, a transparent material or a material, which may transmit light, may be used to cover the penetrated portion of the main plate 20 having the slide loading portion 22.

The main plate 20 has main lever mounting portions 24 on which the main levers 30 are mounted. In the embodiment, the main lever mounting portions 24 may include a first main lever mounting portion 24A and a second main lever mounting portion 24B provided at two opposite sides of the main plate 20. The main lever mounting portion 24 may be provided as a groove structure formed to have a predetermined depth in the Y-axis direction in FIG. 3. The main lever 30 may move in the Y-axis direction on the main lever mounting portion 24. In the embodiment, the main lever mounting portion 24 may further have a main lever spring accommodation groove 25 into which a main lever spring 35 configured to provide a restoring force to the main lever 30 is inserted.

Lateral surface pressing part mounting portions 26, on which the slide lateral surface pressing parts 40 are mounted, are formed in a direction traversing the main lever mounting portions 24 of the main plate 20. In the embodiment, the lateral surface pressing part mounting portion 26 may be provided as a groove structure formed to have a predetermined depth in the X- axis direction in FIG. 3. However, in the embodiment of the present invention, the lateral surface pressing part mounting portion 26 only needs to be formed in the direction traversing the main lever mounting portion 24 and does not need to be necessarily formed in the X-axis direction. In the embodiment, the lateral surface pressing part mounting portions 26 may include a first lateral surface pressing part mounting portion 26A and a second lateral surface pressing part mounting portion 26B provided at two opposite sides of the main plate 20.

End fixing part mounting portions 28 are provided at one side of the slide loading portions 22 of the main plate 20 and formed in a direction in which the slide is loaded (Y-axis direction in the example in FIG. 3). The slide end fixing part 60 may be installed on the end fixing part mounting portion 28 and configured to be movable in the Y-axis direction. In addition, the end fixing part mounting portion 28 may have a protrusion insertion groove 29 into which an unfixing protrusion 63 to be described below is inserted and installed. In the embodiment, the end fixing part mounting portions 28 may include a first end fixing part mounting portion 28A and a second end fixing part mounting portion 28B corresponding to the two slide loading portions 22A and 22B.

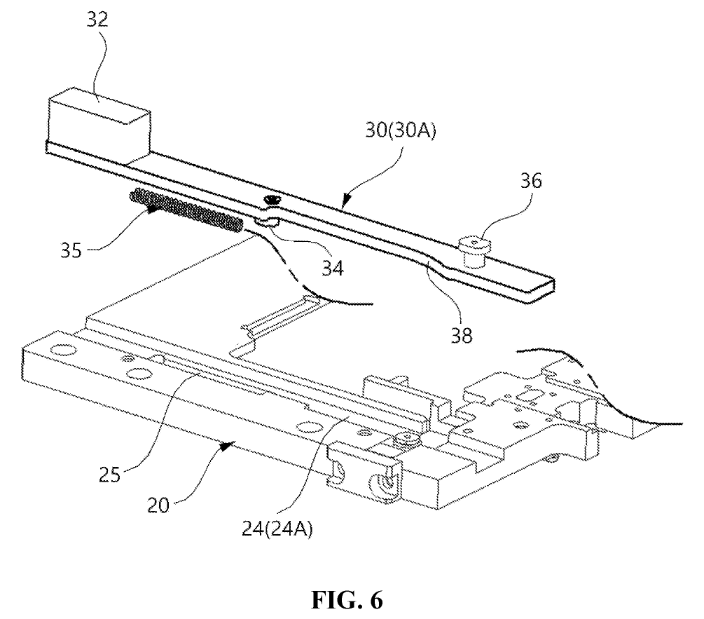

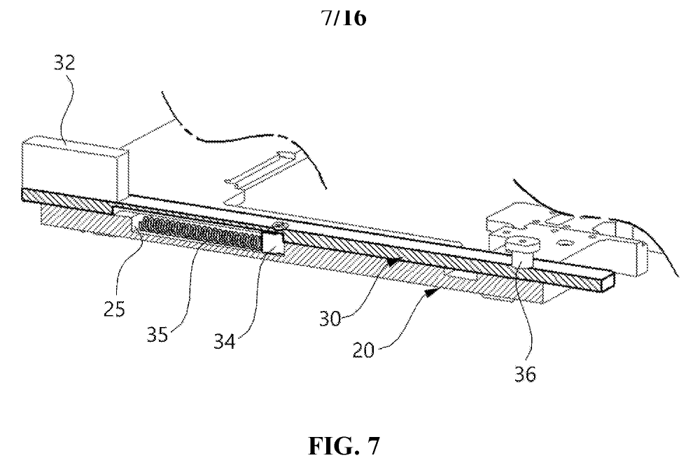

FIG. 6 is a view illustrating a state in which the main lever is mounted on the main plate of the stage according to the embodiment of the present invention, and FIG. 7 is a view illustrating a cross-section (cross-section taken along line B-B' in FIG. 3) in the state in which the main lever is mounted on the main plate of the stage according to the embodiment of the present invention.

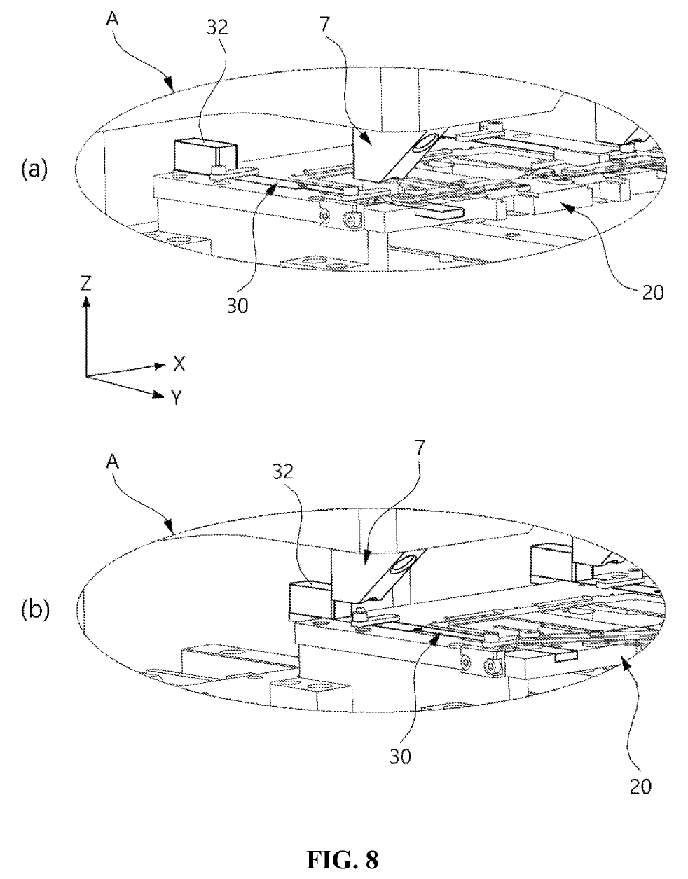

In addition, FIG. 8 is a view illustrating a state in which the main lever of the stage according to the embodiment of the present invention operates to be pressed against the bumper pusher provided in the slide imaging device. Part (a) of FIG. 8 illustrates a state before the main lever comes into contact with the bumper pusher, and part (b) of FIG. 8 illustrates a state after the main lever comes into contact with the bumper pusher.

The main lever 30 may have a bar shape having a predetermined thickness. In the embodiment, the main lever operating bumper 32 may be formed at a predetermined position on the main lever 30. As illustrated in part (a) and part (b) of FIG. 8, when the main lever operating bumper 32 comes into contact with the bumper pusher 7 provided in the slide imaging device 1 as the main plate 20 moves in the Y-axis direction, the main lever operating bumper 32 is caught by the bumper pusher 7, and the main lever 30 moves rearward relative to the main plate 20. That is, in a state in which the main lever 30 is stopped without moving forward because of the bumper pusher 7, only the main plate 20 further moves forward in the Y-axis direction by a predetermined distance. However, in the embodiment of the present invention, the position at which the main lever operating bumper 32 is formed is not limited to that illustrated in FIG. 6 or the like. In addition, the main lever operating bumper 32 may not be provided separately, and one end of the main lever 30 (e.g., an end of the main lever 30 protruding rightward from the main plate 20 in FIG. 3) may be supported by a component corresponding to the bumper pusher 7, such that the main lever 30 may move rearward relative to the main plate 20.

The main lever 30 may be elastically supported by the main lever spring 35. The main lever spring 35 provides a force that restores the main lever 30. In the embodiment, the main lever spring 35 may be accommodated in the main lever spring accommodation groove 25 of the main plate 20, one side of the main lever spring 35 may be supported by the main lever spring accommodation groove 25, and the other side of the main lever spring 35 may elastically support a spring support portion 34 provided to protrude downward from the main lever 30. FIGS. 6 and 7 illustrate the main lever spring 35 configured to be compressed by the rearward movement of the main lever 30. However, in the embodiment of the present invention, the main lever spring 35 may be configured to be stretched by the rearward movement of the main lever 30.

An inclined surface 38 is formed at one side of the lateral surface of the main lever 30. The inclined surface 38 enables the slide lateral surface pressing part 40 to be moved by the forward movement or rearward movement of the main lever 30. In addition, a driving link connection pin 36 is provided on the main lever 30, and one end of the driving link 50 is coupled to the driving link connection pin 36.

Meanwhile, with reference to FIG. 3, the main plate 20 may have main lever separation prevention members 31 configured to prevent separation of the main levers 30 mounted on the main lever mounting portions 24.

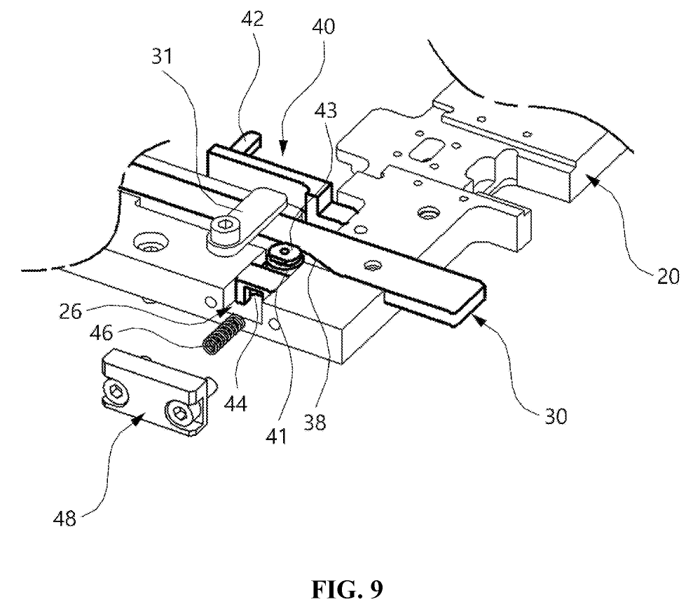

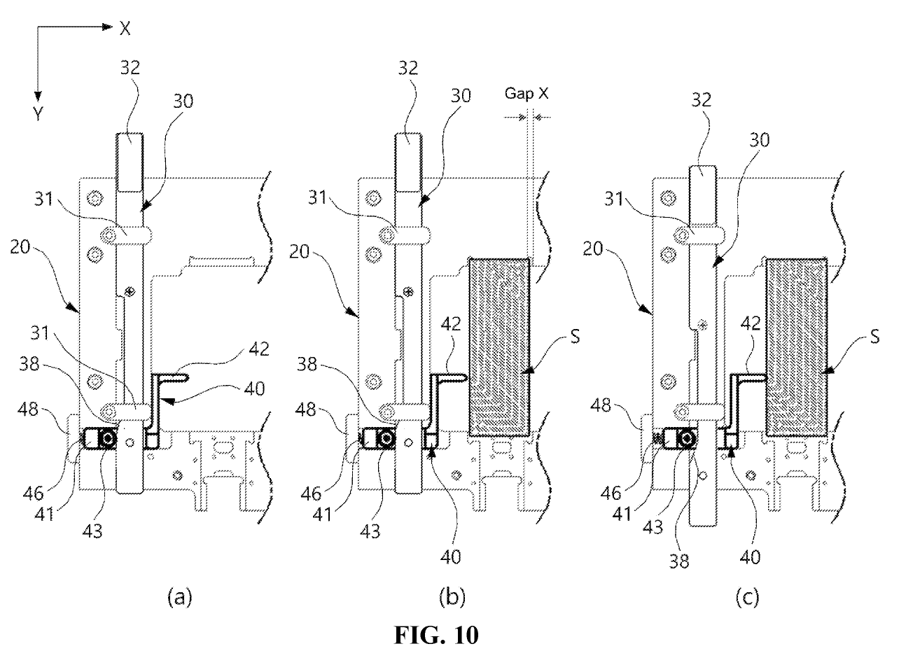

FIG. 9 is a view illustrating a state in which the slide lateral surface pressing part is coupled to the main plate of the stage according to the embodiment of the present invention, and FIG. 10 is a view illustrating a state in which the slide lateral surface pressing part operates in accordance with the operation of the main lever in the stage according to the embodiment of the present invention. Part (a) of FIG. 10 illustrates a state in which the lateral surface pressing part is spaced apart from the slide, part (b) of FIG. 10 illustrates a state in which the lateral surface pressing part moves toward the slide, and part (c) of FIG. 10 illustrates a state in which the lateral surface pressing part presses the lateral surface of the slide.

The slide lateral surface pressing part 40 includes a sliding block 41 disposed on the lateral surface pressing part mounting portion 26 of the main plate 20 in a direction traversing the main lever 30, and a slide contact portion 42 protruding toward the slide S loaded onto the slide loading portion 22. An inclined surface contact portion 43 may be provided on the sliding block 41 and configured to come into contact with the inclined surface 38 of the main lever 30. A lateral surface pressing part spring accommodation portion 44 may be formed at one side of the sliding block 41 and configured to accommodate a lateral surface pressing part spring 46 configured to press the slide lateral surface pressing part 40 in the direction in which the slide S is loaded. A lateral surface pressing part spring bracket 48 coupled to a lateral portion of the main plate 20 may be further provided to prevent the separation of the lateral surface pressing part spring 46.

With reference to part (a) of FIG. 10, in the state in which the main lever 30 is moved rearward relative to the main plate 20, the slide lateral surface pressing part 40 is positioned at the left side based on the X-axis direction. The state illustrated in part (a) of FIG. 10 is a state in which the main plate 20 is moved to a position at which the slide S is loaded or unloaded, the main lever 30 is moved rearward relative to the main plate 20, and the lateral surface of the slide S is released by the slide lateral surface pressing part 40. In the state illustrated in part (a) of FIG. 10, the slide S is loaded or unloaded.

With reference to part (b) of FIG. 10, the slide S is loaded onto the slide loading portion 22 of the main plate 20. The slide S loaded onto the slide loading portion 22 may have a clearance corresponding to 'gap X' in the X-axis direction.

With reference to part (c) of FIG. 10, the main lever 30 moves forward relative to the main plate 20. Because the sliding block 41 is in the state of being pressed by the lateral surface pressing part spring 46 in the direction in which the slide S is loaded, the inclined surface contact portion 43 moves along the inclined surface 38 of the main lever 30 in the direction in which the slide S is loaded, such that the slide contact portion 42 of the slide lateral surface pressing part 40 comes into contact with and presses the lateral surface of the slide S. Therefore, 'gap X' illustrated in part (b) of FIG. 10 is eliminated, and the slide S is tightly attached and aligned toward one side.

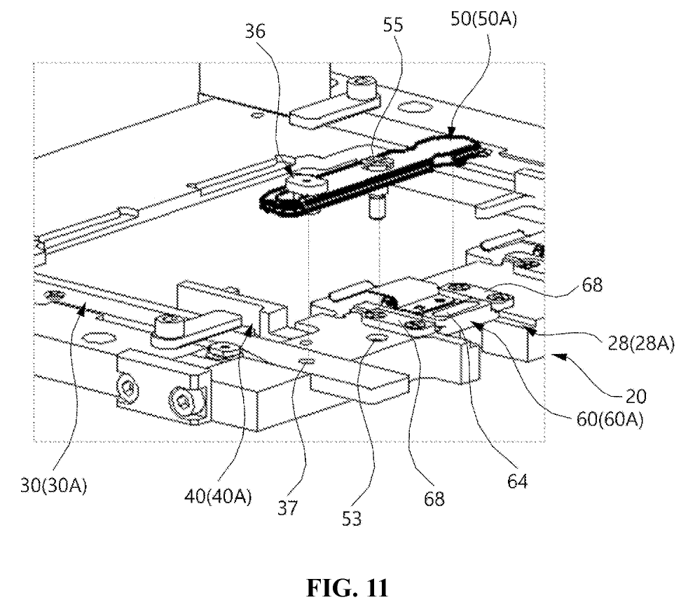

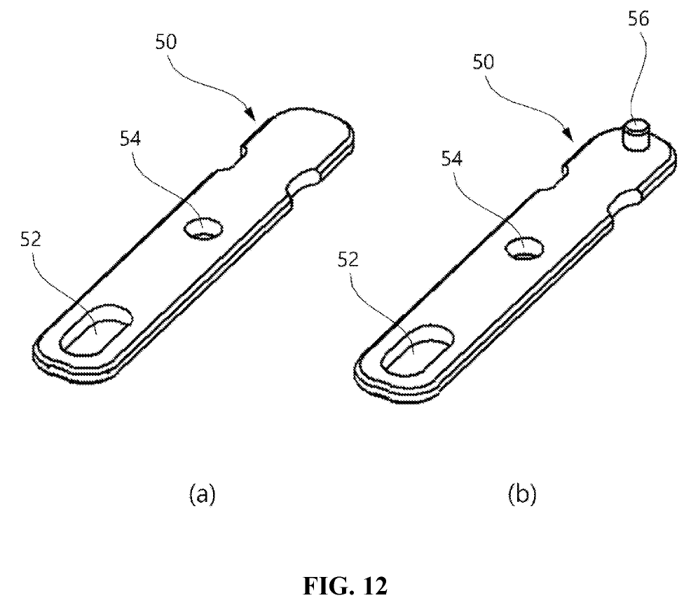

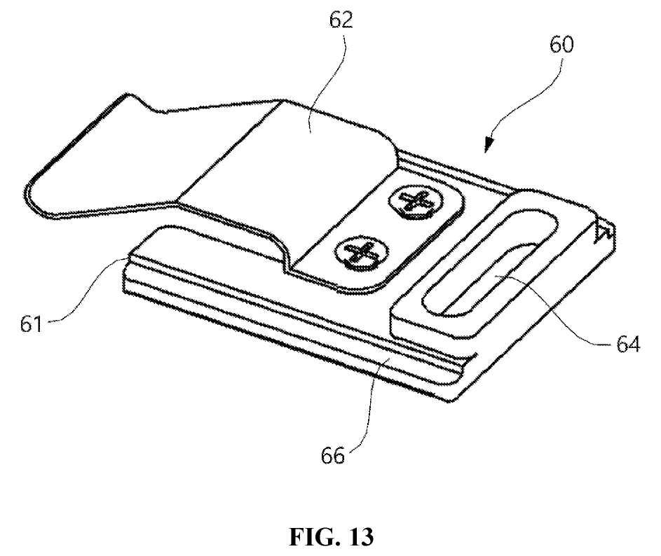

FIG. 11 is a view illustrating a state in which the slide end fixing part and the driving link, which is configured to operate the slide end fixing part, are mounted on the main plate of the stage according to the embodiment of the present invention. FIG. 12 is a view illustrating the driving link provided in the stage according to the embodiment of the present invention, and FIG. 13 is a perspective view of the slide end fixing part provided in the stage according to the embodiment of the present invention.

Part (a) of FIG. 12 is a perspective view when the driving link 50 is viewed from above, and part (b) of FIG. 12 is a perspective view when the driving link 50 is viewed from below. A rotation center hole 54 is formed in a central portion of the driving link 50, and a main lever connection hole 52 is formed at one side of the driving link 50. The main lever connection hole 52 may be formed in a long hole shape. An operating protrusion 56 configured to be coupled to an operating hole 64 of the slide end fixing part 60 may be provided at a lower side of a portion of the driving link 50 opposite to the portion of the driving link 50 in which the main lever connection hole 52 is formed.

With reference to FIG. 13, the slide end fixing part 60 includes the operating hole 64 formed in a long hole shape and includes a flat spring 62. Sliding guides 66 may be formed at two opposite sides of the slide end fixing part 60 and configured to assist a sliding movement of the slide end fixing part 60. The flat spring 62 serves to elastically support the slide S from above. One end 61 of the slide end fixing part 60 may come into contact with one side of the slide S.

With reference to FIG. 11, the slide end fixing part 60 is mounted on the end fixing part mounting portion 28 of the main plate 20. A mounting assistance plate 68 is fixed to the main plate 20 while covering the sliding guide 66 of the slide end fixing part 60, such that the slide end fixing part 60 may be mounted on the end fixing part mounting portion 28 of the main plate 20.

A driving link fixing bolt 55 is inserted into the rotation center hole 54 of the driving link 50, and the driving link fixing bolt 55 is fixed to a driving link fixing bolt insertion hole 53 of the main plate 20, such that the driving link 50 may be rotatably fixed to the main plate 20. The driving link connection pin 36 is inserted into the main lever connection hole 52 of the driving link 50 and coupled to a driving link connection pin insertion hole 37 of the main lever 30. The operating protrusion 56 of the driving link 50 is inserted into the operating hole 64 of the slide end fixing part 60. With this coupling configuration, the driving link 50 connects the main lever 30 and the slide end fixing part 60 and moves the slide end fixing part 60 forward or rearward in accordance with the rearward movement or forward movement of the main lever 30.

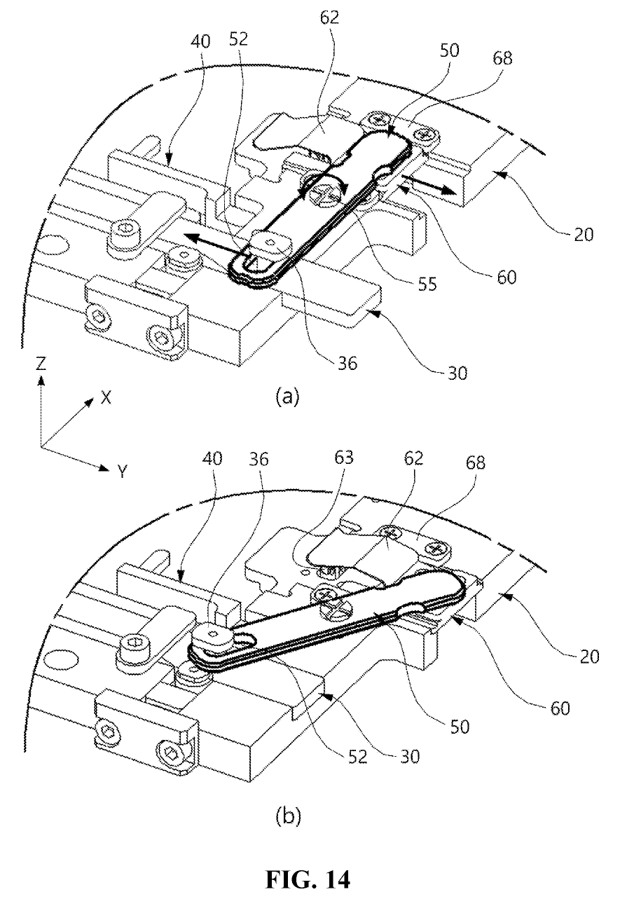

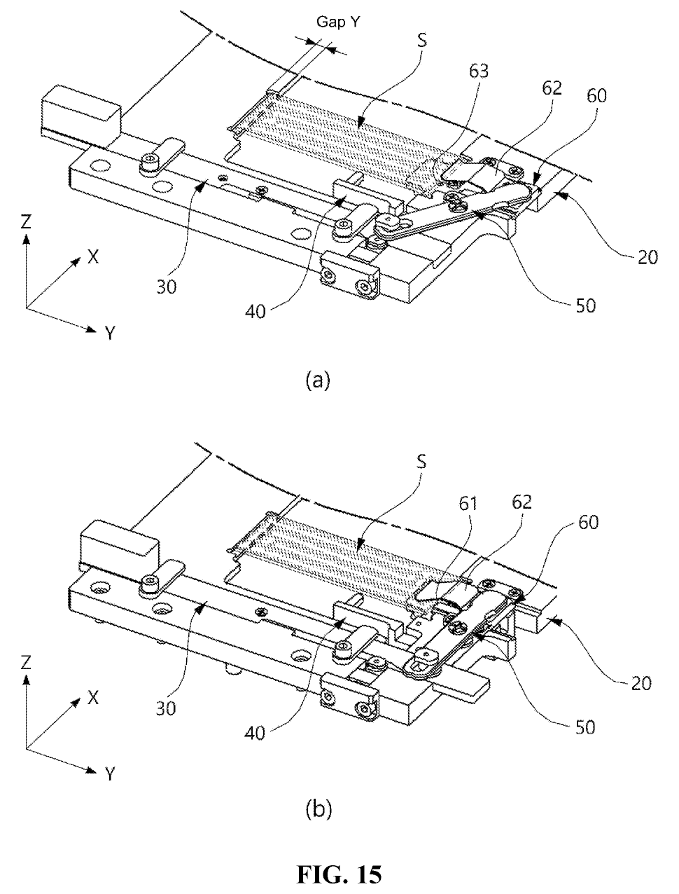

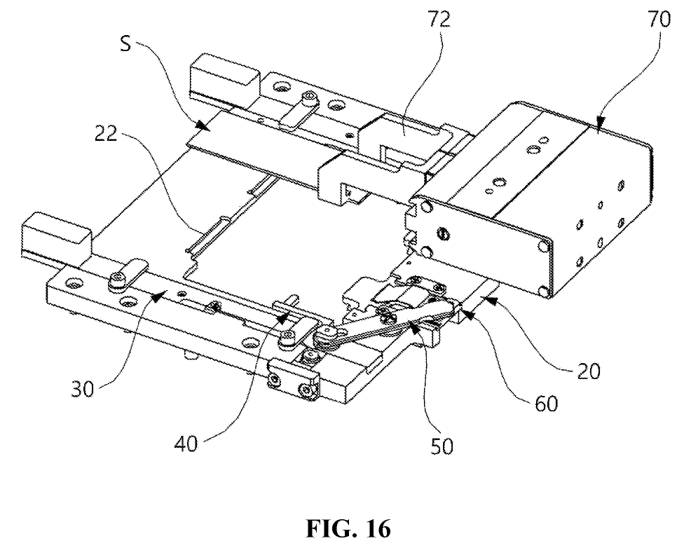

FIG. 14 is a view illustrating a state in which the driving link operates the slide end fixing part while being rotated by the operation of the main lever in the stage according to the embodiment of the present invention, and FIG. 15 is a view illustrating a state in which the slide is loaded onto the stage according to the embodiment of the present invention, and the slide is aligned and fixed by the slide lateral surface pressing part and the slide end fixing part by the operation of the main lever. In addition, FIG. 16 is a view illustrating a state in which the slide is loaded onto the stage according to the embodiment of the present invention by using a slide loader.

Part (a) of FIG. 14 illustrates a state in which the main lever 30 is not moved rearward relative to the main plate 20, and part (b) of FIG. 14 illustrates a state in which the main lever 30 is moved rearward relative to the main plate 20. As the main lever 30 moves rearward, the driving link 50 rotates about the driving link fixing bolt 55, and the slide end fixing part 60 moves from a fixed position illustrated in part (a) of FIG. 14 to a released position illustrated in part (b) of FIG. 14. Meanwhile, the unfixing protrusion 63 is provided in the protrusion insertion groove 29 of the end fixing part mounting portion 28 of the main plate 20. As illustrated in part (b) of FIG. 14, the flat spring 62 is moved upward by the unfixing protrusion 63 when the slide end fixing part 60 moves to the released position at which the slide S is not fixed.

With reference to FIG. 16, at the released position at which the slide lateral surface pressing part 40 and the slide end fixing part 60 are spaced apart from the slide loading portion 22 as the main lever 30 is moved rearward relative to the main plate 20, a slide loader 70 having a gripper 72 configured to grip the slide S is used to transfer the slide S to the slide loading portion 22. The released positions of the slide lateral surface pressing part 40 and the slide end fixing part 60 in FIG. 16 may be implemented as the main lever 30 is moved rearward relative to the main plate 20 by the bumper pusher 7 when the stage 100 is moved to the position at which the slide S is loaded or unloaded.

When the slide S is loaded onto the slide loading portion 22 by using the slide loader 70, the position of the slide S is aligned and fixed, as illustrated in FIG. 15. Part (a) of FIG. 15 illustrates a state in which the slide S is loaded onto the slide loading portion 22 in the state in which the slide end fixing part 60 is positioned at the released position, and part (b) of FIG. 15 illustrates a state in which the slide end fixing part 60 is moved to the fixed position after the slide S is loaded.

In the state illustrated in part (a) of FIG. 15 , the slide end fixing part 60 and the slide lateral surface pressing part 40 are at the released positions at which the slide end fixing part 60 and the slide lateral surface pressing part 40 are spaced apart from the slide S. In the state illustrated in part (a) of FIG. 15 , there may exist not only 'gap X' illustrated in part (b) of but also a clearance such as 'gap Y' in the Y-axis direction.

When the main lever 30 moves forward relative to the main plate 20, the slide lateral surface pressing part 40 moves in the X-axis direction to press the lateral surface of the slide S, and the slide end fixing part 60 moves in the Y-axis direction toward the slide S, as illustrated in part (b) of FIG. 15. The slide lateral surface pressing part 40 presses the lateral surface of the slide S, such that the slide S is tightly attached to the slide loading portion 22 in the X-axis direction, as illustrated in part (c) of FIG. 10. In addition, the end 61 of the slide end fixing part 60 comes into contact with and presses one end of the slide S based on the Y-axis direction, such that the clearance such as 'gap Y' is eliminated, and the slide S is tightly attached to the slide loading portion 22 in the Y-axis direction. Meanwhile, the flat spring 62 of the slide end fixing part 60 is not supported by the unfixing protrusion 63, and the flat spring 62 fixes the slide S by pressing the upper surface of one end of the slide S.

According to the configuration of the stage assembly 10 of the slide imaging device 1 according to the present invention, the fixed state of the slide S loaded onto the slide loading portion 22 is released as the stage 100 moves to the position at which the slide S is loaded or unloaded. In addition, when the stage 100 is moved to the position, at which images of the slide S are captured, after a new slide S is loaded onto the slide loading portion 22, the slide S loaded onto the slide loading portion 22 is automatically aligned and fixed. In addition, according to the present invention, it is possible to reduce an unnecessary operation of the slide loader 70 when the slide S is unloaded or loaded. In addition, the slide loading portions 22 may be provided as a plurality of slide loading portions 22, thereby improving processing speed for the slide S.

The above description is simply given for illustratively describing the technical spirit of the present invention, and those skilled in the art to which the present invention pertains will appreciate that various modifications, changes, and substitutions are possible without departing from the essential characteristics of the present invention. Accordingly, the embodiments disclosed in the present invention and the accompanying drawings are intended not to limit but to describe the technical spirit of the present invention, and the scope of the technical spirit of the present invention is not limited by the embodiments and the accompanying drawings. The protective scope of the present invention should be construed based on the following claims, and all the technical spirit in the equivalent scope thereto should be construed as falling within the scope of the present invention.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A stage provided in a slide imaging device, the stage comprising:
a main plate having a slide loading portion onto which a slide is loaded;
a main lever provided on the main plate and configured to be movable in a first direction;
and at least one of a slide lateral surface pressing part configured to press or release a lateral surface of the slide in conjunction with a movement of the main lever in the first direction or a slide end fixing part configured to press or release an end of the slide in conjunction with the
movement of the main lever in the first direction.

2. The stage of claim 1, wherein the main lever is moved rearward in the first direction relative to the main plate as a part of the main lever comes into contact with a structure provided in the slide imaging device when the stage moves to a loading or unloading position of the slide.

3. The stage of claim 2, wherein a main lever operating bumper protruding from the main lever is provided on the main lever, and the structure of the slide imaging device is a bumper pusher configured to come into contact with the main lever operating bumper.

4. The stage of claim 2, wherein a main lever mounting portion on which the main lever is mounted and movable in the first direction is provided as a groove structure in the main plate, and the main lever mounting portion has a main lever spring configured to provide a restoring force to the main lever.

5. The stage of claim 1, wherein a lateral surface pressing part mounting portion is formed on the main plate and configured to guide the slide lateral surface pressing part in a direction traversing the main lever.

6. The stage of claim 5, wherein the slide lateral surface pressing part comprises:
a sliding block disposed on the lateral surface pressing part mounting portion; and
a slide contact portion configured to come into contact with the lateral surface of the slide.

7. The stage of claim 6, wherein the main lever has an inclined surface, the sliding block has an inclined surface contact portion configured to adjoin the inclined surface, and the sliding block is elastically supported by a lateral surface pressing part spring, such that the slide lateral surface pressing part is moved, by a movement of the main lever in the first direction, to a position at which the slide lateral surface pressing part presses or releases the lateral surface of the slide.

8. The stage of claim 7, further comprising:
a lateral surface pressing part spring bracket coupled to the main plate to prevent separation of the lateral surface pressing part spring.

9. The stage of claim 1, wherein the slide end fixing part is mounted on an end fixing part mounting portion, which is provided at one side of the slide loading portion of the main plate,
and configured to be movable in the first direction.

10. The stage of claim 9, wherein the slide end fixing part comprises a flat spring
configured to press an upper portion of one side of the slide, and one end of the slide end fixing part comes into contact with one side of the slide to align the slide in the first direction.

11. The stage of claim 10, wherein the end fixing part mounting portion has an unfixing
protrusion configured to move the flat spring upward when the slide end fixing part moves in a direction away from the slide.

12. The stage of claim 9, wherein sliding guides are formed at two opposite sides of the slide end fixing part and configured to assist a sliding movement of the slide end fixing part.

13. The stage of claim 9, further comprising:
a driving link configured to connect one end of the main lever and the slide end fixing part to allow the main lever and the slide end fixing part to operate in conjunction with each other.

14. The stage of claim 13, wherein the driving link comprises:
a rotation center hole provided in a central portion thereof and rotatably coupled to the main plate;
a main lever connection hole connected to the main lever and having a long hole shape;
and an operating protrusion connected to the slide end fixing part.

15. The stage of claim 14, wherein the slide end fixing part has an operating hole having a long hole shape into which the operating protrusion is inserted.

16. The stage of claim 1, wherein the slide loading portion is provided as a plurality of slide loading portions on the main plate, and the main lever, the lateral surface pressing part, and the slide end fixing part are provided to correspond to each of the plurality of slide loading portions.

17. A slide imaging device comprising:
a casing having an internal space;
an image capturing part provided in the casing; and
a slide assembly onto which a slide, which is to be subjected to image capturing by the image capturing part, is loaded,
wherein the slide assembly comprises a stage, and
wherein the stage comprises:
a main plate having a slide loading portion onto which the slide is loaded;
a main lever provided on the main plate and configured to be movable in a first direction;
and at least one of a slide lateral surface pressing part configured to press or release a lateral surface of the slide in conjunction with a movement of the main lever in the first direction or a slide end fixing part configured to press or release an end of the slide in conjunction with the movement of the main lever in the first direction.

18. The slide imaging device of claim 17, wherein the stage is mounted on a block configured to be movable in at least one of the first direction or a second direction perpendicular to the first direction.

19. The slide imaging device of claim 17, further comprising:
a slide loader configured to load or unload the slide onto or from the stage.

20. The slide imaging device of claim 19, wherein the slide is loaded or unloaded by the slide loader after the stage reaches a position at which the slide is loaded or unloaded, and
wherein a bumper pusher configured to come into contact with the main lever of the stage and move the main lever rearward is provided at the position at which the slide is loaded or unloaded.
